(19) United States
(12) Patent Application Publication
(10) Pub. No.: US 2017/0056294 A1
(43) Pub. Date: Mar. 2, 2017

(54) SEQUENTIAL DISPENSING APPARATUS AND METHOD

(71) Applicant: EDUARDO SANTAMARIA, Coral Gables, FL (US)

(72) Inventor: EDUARDO SANTAMARIA, Coral Gables, FL (US)

(73) Assignee: Eduardo Santamaria, Coral Gables, FL (US)

(21) Appl. No.: 15/246,968

(22) Filed: Aug. 25, 2016

Related U.S. Application Data
(60) Provisional application No. 62/209,688, filed on Aug. 25, 2015.

(51) Int. Cl. A61J 7/00; B65D 83/04

(52) U.S. Cl. CPC A61J 7/0084; B65D 83/04

(57) ABSTRACT

The present invention discloses a multi-compartment storage apparatus that does not require any electrical power but that still prevents the compartments from being opened out of order. Embodiments of this invention are directed to locking, multi-compartment storage containers for the storing and dispensing of medication.

### CROSS-REFERENCE TO RELATED APPLICATIONS

This utility patent application is a non-provisional of, and claims the benefit of priority of, currently pending U.S. Provisional Patent application No. 62/209,688, filed on 25 Aug. 2015, which is incorporated by reference as if fully set forth herein.

### STATEMENT REGARDING FEDERALLY SPONSORED-RESEARCH OR DEVELOPMENT

None.

### FIELD OF THE INVENTION

The invention disclosed relates to the field of mechanical storage and sorting apparatus and methods of use.

### BACKGROUND OF THE INVENTION

It is well known that the problem of patients taking medication regiments at proper times and in the correct order is an important issue. Especially among the elderly, who are burdened with having to take the most medications, the problem of overdosing, or mis-dosing, can be a lethal one.

Many attempts to solve this problem may be found in the art. From simple, multi-compartment containers, to expensive, electronically controlled dispensing systems have been proposed as means to solve this problem. While it is true that electronic dispensing systems take all of the guess-work out of proper patient dosing, they are cost-prohibitive and out of the question for most patients. Furthermore, electronic dispensers are not feasible solutions in developing countries where reliable electrical sources are not available.

Simple, multi-compartment containers, while being simple to use and inexpensive to manufacture, are prone to errors. A user who is not careful may inadvertently open the wrong compartment and take the wrong set of medications. Unfortunately, this type of inexpensive dispenser is the one that is most often used by the poor and elderly—precisely the segment of user that is most prone to commit errors in taking their medications.

It would, therefore, be desirable to have a multi-compartment storage apparatus that does not require any electrical power but that still prevents the compartments from being opened out of order, thereby preventing potentially fatal errors. It would be further desirable to have a sequential dispensing apparatus that is inexpensive to manufacture and affordable to a wide market of users.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provision; or is known to be relevant to an attempt to solve any problem with which this specification is concerned.

### SUMMARY

Briefly, according to an embodiment of the present disclosure, a sequential dispensing apparatus may comprise multiple compartments. Each of the compartments has an independently locking cover with a sequential locking mechanism that cannot be unlocked or opened before the preceding compartment has been opened. In this way, embodiments of the present invention would prevent potentially fatal errors by preventing the opening of compartments out of sequence. For example, the “Tuesday Morning” compartment can only be opened after the “Monday Night” compartment has been opened.

A preferred embodiment of the present invention may comprise a radial container with divisions for fourteen (14) separate compartments (two for each day of the week—morning and night). Each compartment would further comprise a hinged lid and a mechanical locking mechanism that only permits a precise sequential order for the opening of each compartment. The mechanical locking mechanism is further comprised of a locking pin, a locking pin housing, and a locking pin track. Each compartment and compartment lid are further comprised of mating features such that when the lock in one compartment is engaged, its locking features engage with the next compartment and compartment lid in the sequence, thereby preventing access to the next compartment.

A method of using a preferred embodiment of the present invention may comprise the steps of: identifying the “starting” compartment; loading each compartment in reverse sequential order beginning with the “ending” compartment, which would be the compartment immediately preceding the “starting” compartment; closing the lid of the now loaded compartment; locking the lid of the loaded compartment by sliding the locking mechanism of the next immediately preceding compartment; loading and locking each of the next preceding compartments until you have loaded the “starting” compartment. The “starting” compartment will now be the only compartment that does not have a locked lid and access to any other compartment is prevented. Once the dosage from the unlocked compartment is taken, the user may then disengage the locking mechanism to unlock the next sequential compartment. In this way, any given compartment may only be unlocked after the immediately preceding compartment has been opened.

The present invention may address one or more of the problems and deficiencies of the prior art discussed above. However, it is contemplated that the invention may prove useful in addressing other problems and deficiencies in a number of technical areas. For example, while the invention may be described and utilized with respect to the dispensing of medications, this is not meant as a limitation, but only as an illustrative example. It is contemplated to be within the scope of the present invention that embodiments thereof may be envisioned in non-medical applications. Indeed, any use that requires sorting, storage, and or sequential dispensing of objects may benefit from the teachings of this disclosure. For example, an embodiment of the present invention may be used to sequentially reveal components in a game system. Therefore, the claimed invention should not necessarily be construed as limited to addressing any of the particular problems or deficiencies discussed herein.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 illustrates a composite of multiple views of a sequential dispensing apparatus, according to an embodiment herein; and

FIG. 2 illustrates a flowchart of a method of using a sequential dispensing apparatus, according to an embodiment herein.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

In the Summary above, in the Description and appended Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or van contain not only components A, B, and C, but also one or more other components or structures.

The term “at least” followed by a number is used herein to denote the start of a range beginning with that number (which may be a range having an upper limit or no upper limit, depending on the variable being defined). For example, “at least 1” means 1 more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

The term “mechanical features” is used herein to mean features of a component, mechanical or geometric, which have a functional purpose of attaching or linking that component to one or more other components with compatible or corresponding mechanical features. An example of a mechanical feature is a slot in a component, where said slot is designed to accept a tab from another component and the union of the slot and tab from the two components effectively links, attaches, fixes, and/or locks the components together. The term “mechanical features” refers to, but is not limited to: clips, hooks, hook and loop fasteners, slot and tabs, all male and female fasteners, screws, bolts, nuts, holes that have been tapped, latches, pins, etc.

While the specification will conclude with claims defining the features of embodiments of the invention that are regarded as novel, it is believed that the invention will be better understood from a consideration of the following description in conjunction with the figures, in which like reference numerals are carried forward.

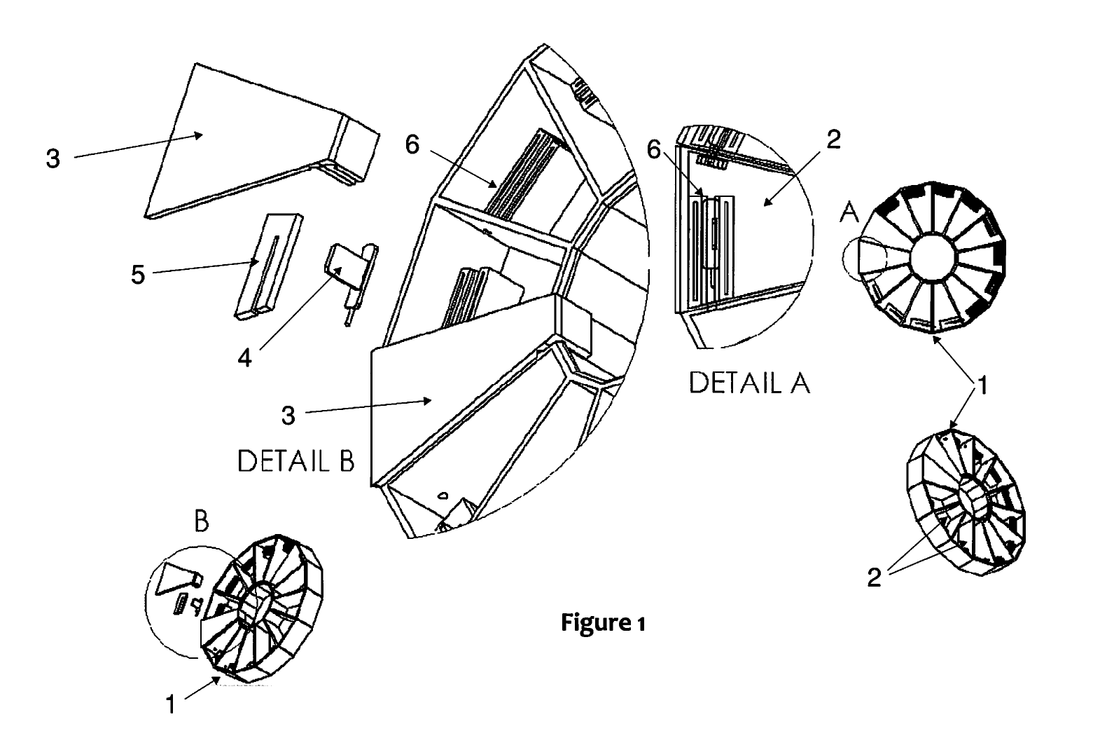

We refer now to FIG. 1, which shows various views of a preferred embodiment of the present invention. The apparatus 1 is comprised of multiple compartments 2, multiple lids 3, and multiple locking mechanisms (items 4, 5, and 6).

It is contemplated that the apparatus 1 may be comprised of any number of compartments 2, but would require at least two (2) compartments. The embodiment shown in FIG. 1 shows a version of the apparatus comprising fourteen (14) compartments. This would allow, by way of example and not limitation, for the grouping of fourteen separate doses of medications, such as for two doses per day, for seven days. Embodiments of the invention could also comprise seven (7) compartments representing one for each day of the week, twenty-one (21) compartments representing three times per day for seven days, or any other number of compartments as may be desired.

The embodiment shown in FIG. 1 illustrates an embodiment of the present invention where the compartments are arranged radially. It may be appreciated, however, that the compartments may be arranged linearly (one next to the other in a line) or stacked (one on top of the other), so long as the locking mechanism of one compartment is mechanically communicated with the next compartment in the sequence. A benefit of the radial arrangement is that embodiments of the invention may have a “starting” compartment at any compartment in the sequence and continue in order from that point.

Embodiments of the compartment 2 comprise four walls and a floor defining a partially enclosed area. The compartments are configured such that there is no means for articles contained in the compartment to traverse from one compartment to the other. The compartment further comprises features for containing the lock 4. Such features may be in the form of a lock guide 6 and a retainer 5. The lock comprises an actuation portion and a locking portion. The actuation portion is the feature that the user interacts with in order to lock or unlock the next compartment, such as a tab. The locking portion is the feature that traverses from one compartment to the next compartment and interfaces with the next compartment's lid in order to secure it closed. This lock feature may be a pin or other protrusion that traverses through mated openings in the compartment wall and the next compartment's lid.

Further embodiments of the locking mechanism may include springs, or spring elements, configured to apply a constant force to the lock in order to keep the lock engaged until the user pulls back the lock to disengage the next compartment's lid. Other embodiments of the locking mechanism may include detents, or other features as is known in the art to keep the lock in either the open, closed, or both positions.

While various embodiments of the locking mechanism are contemplated to be within the scope of the present invention, we note here that the locking mechanism is substantially located within the compartment such that it can only be disengaged to open the next compartment in the sequence once its corresponding lid has been unlocked by disengaging the previous locking mechanism.

Embodiments of the lid 3 may comprise a sealing portion configured to block access to the corresponding compartment, an attachment portion configured to attach the lid to the compartment, a hinge portion configured to allow the sealing portion to separate from the compartment and allow access to the interior of the compartment, and a locking portion configured to accept the lock from the sequentially preceding compartment.

Further embodiments of the lid may comprise other features, such as airtight or watertight gaskets configured to sealably mate with the compartment or a one or more snap or detent feature to keep the lid in a closed position even though the lock has been disengaged. Yet other embodiments of the lid may further comprise a spring element configured to automatically open, or separate, the lid from the compartment upon disengaging the lock.

Other embodiments of the apparatus may comprise other features and components such as indicia on the lids and/or compartments to indicate compartment number, day of the week, day of the month, morning, night, or other identifying mark or combination of marks. Further embodiments may comprise “windows” or other means of seeing the contents of a compartment without unlocking and opening the lid.

One having skill in the art will readily appreciate that any number of materials may be chosen for the manufacture of the apparatus and its various components. In a preferred embodiment, the compartments and lids may be made out of injection molded plastic in order to maintain sanitary storage of medicines at a low manufacturing cost. Each compartment may be manufactured as a separate piece and mechanically or chemically fastened to the next compartment, or all compartments may be molded together as one piece. In likewise manner, the lids may be molded together with the compartments, or they may be separate pieces that are mechanically or chemically fastened to the compartment.

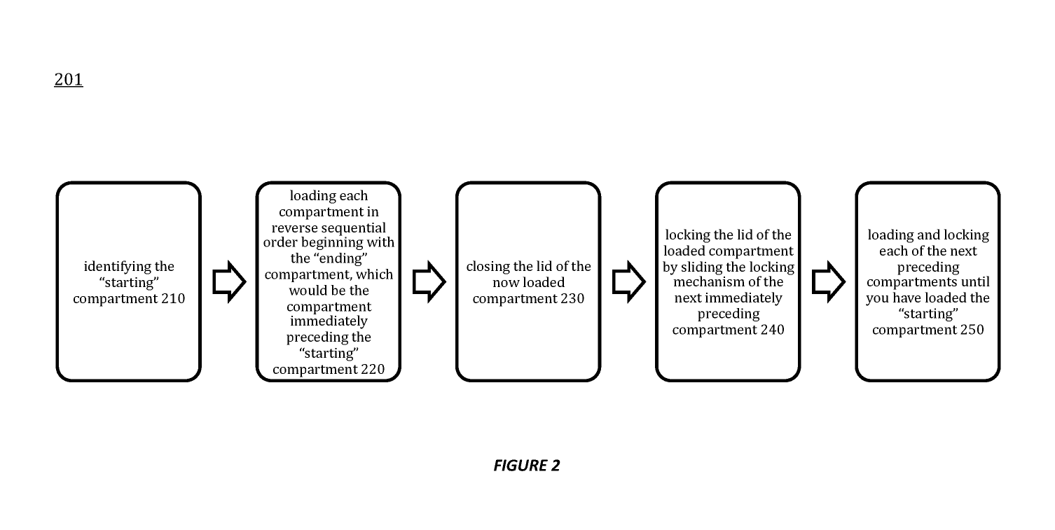

An embodiment of a method of using the present invention is shown in FIG. 2. A method 201 of using a preferred embodiment of the present invention may comprise the steps of: identifying the “starting” compartment 210 and ending compartment; loading each compartment in reverse sequential order beginning with the “ending” compartment, which would be the compartment immediately preceding the “starting” compartment 220; closing the lid of the now loaded compartment 230; locking the lid of the loaded compartment by sliding the locking mechanism of the next immediately preceding compartment 240; and loading and locking each of the next preceding compartments until you have loaded the “starting” compartment 250. The “starting” compartment will now be the only compartment that does not have a locked lid and access to any other compartment is prevented. Once the dosage from the unlocked compartment is taken, the user may then disengage the locking mechanism to unlock the next sequential compartment. In this way, any given compartment may only be unlocked after the immediately preceding compartment has been opened.

Therefore, while there has been described what is presently considered to be the preferred embodiment, it will be understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

What is claimed is:

1. A sequentially dispensing, multiple compartment, apparatus comprising:
a plurality of compartments, each having a compartment interior space defined by four walls and a floor, where each compartment is adjacent to the next compartment;
a plurality of hinged lids, each hinged lid hingedly attached to each compartment and further configured with a mechanical locking mechanism that only permits a precise sequential order for the opening of each compartment, where the mechanical locking mechanism is further comprised of a locking pin, a locking pin housing, and a locking pin track.

2. The apparatus of claim 1 where each compartment and hinged lid are further comprised of mating features such that when the lock in one compartment is engaged, its locking features engage with the next compartment and hinged lid in the sequence, thereby preventing access to the next compartment.

3. The apparatus of claim 1 where the plurality of compartments are arranged radially so that a first compartment is communicative with a last compartment.

4. A method using a sequentially dispensing, multiple compartment, apparatus, the method steps comprising:
providing an apparatus with a plurality of compartments, each having a compartment interior space defined by four walls and a floor, where each compartment is adjacent to the next compartment, and a plurality of hinged lids, each hinged lid hingedly attached to each compartment and further configured with a mechanical locking mechanism that only permits a precise sequential order for the opening of each compartment, where the mechanical locking mechanism is further comprised of a locking pin, a locking pin housing, and a locking pin track;
identifying a starting compartment and an ending compartment;
loading each compartment in reverse sequential order beginning with the “ending” compartment, which would be the compartment immediately preceding the “starting” compartment;
closing the lid of the now loaded compartment;
locking the lid of the loaded compartment by sliding the locking mechanism of the next immediately preceding compartment; and
loading and locking each of the next preceding compartments until you have loaded the “starting” compartment; whereby
the “starting” compartment will now be the only compartment that does not have a locked lid and access to any other compartment is prevented.
